(19) United States
(12) Patent Application Publication
(10) Pub. No.: US 2022/0301388 A1
(43) Pub. Date: Sep. 22, 2022

(54) SKILL-BASED TEMPORAL OPERATIVE SELECTION CONTROL DEVICE FOR GAMES

(71) Applicant: Epic Tech, LLC, Suwanee, GA (US)

(72) Inventor: Steven Wesley Davis, Suwanee, GA (US)

(73) Assignee: Epic Tech, LLC, Suwanee, GA (US)

(21) Appl. No.: 17/672,907

(22) Filed: Feb. 16, 2022

Related U.S. Application Data
(60) Provisional application No. 63/172,289, filed on Apr. 8, 2021.
(60) Provisional application No. 63/166,009, filed on Mar. 25, 2021.
(60) Provisional application No. 63/163,498, filed on Mar. 19, 2021.
(60) Provisional application No. 63/161,936, filed on Mar. 16, 2021.

(51) Int. Cl. G07F 17/32; G07F 17/34

(52) U.S. Cl. CPC G07F 17/3213; G07F 17/34

(57) ABSTRACT

A gaming system with an input device for play of a game as shown on a display device for a predetermined time, in which a temporal operative skill-based variable selection device has at least a first outcome portion and a second outcome portion with a movable indicator configured for moving therebetween during a predetermined travel time between the opposing first and second extent positions, whereby the player actuating the input device during the display of the variable selection device, is awarded a value associated with the respective first or second outcome portion if the indicator is in the win portion of the variable selection device. An embodiment may have outcome portions of a win portion and a non-win portion, whereby an award is obtained by skillfully actuating the input device with the indicator in the win portion. A method of skillfully selecting a prize by actuation of an input device when an indicator value is within an outcome portion is disclosed. An electronic game and method for same is disclosed.

### TECHNICAL FIELD

The present invention relates to input control devices for play of games. More particularly, the present invention relates to input control devices having a skill-based time or temporal operative variable selection device for play of games including electronic redemption games.

### BACKGROUND OF THE INVENTION

Games provide players with amusing yet often intellectually challenging diversionary leisure activities, including for individual and group play events. Such games include board games, card games, and electronic games. Some board games include accessory devices for selective control of game play. These accessory devices include dice, spinners, timers, and random draw cards that contain instructions, which affect the play of the game. For example, the upward displayed value of thrown dice may provide the number of position movements a player may make. A timer may limit the period in which a player may take an action.

Electronic games typically have a player-actuated input control device or button. The player presses the button to selectively operate a feature or action of the game. For example, the player registers with the electronic game such as providing a game play token or fee, and subsequently, plays one or more games upon actuation of the play button. Some games include a skill feature that is operative during play. Skill-based electronic redemption games typically require some level of skill to accomplish a task in order to win a game, a task, or game element, an achieve a win value, a prize, improved play opportunity, or score, which may be rewarded with points, credits, other such designation, or advantages in play of the game leading to a win. In some electronic games, the accumulated points or credits may be exchanged for non-cash merchandise, such as small toys, novelties, gift cards, or other merchandise or services depending on the jurisdiction in which the skill-based redemption game is located.

The skill-based task exercises a player's experience with game and its particular task as well as a player's observational and determinative skills to improve a resulting action. The skill-based feature typically may be enhanced by player attention during play and by development of response abilities, which feature maintains player interest in play of a game. To facilitate interest, the selection feature of the game needs to present a challenging opportunity requiring concentration and acuity for actuating the input to select and implement the skill feature. It is to such that the present invention is directed.

### SUMMARY OF THE INVENTION

The present invention meets the need in the art by providing a skill-based variable selection control device for players to have a challenging opportunity to exercise concentration and acuity during play of a game for seeking a prize award. More particularly, the present invention provides a gaming system comprising at least one input device; at least one display device; and at least one processor. The processor is configured to: i) receive one or more requests, via the input device, from a player for play of game actions during a game for display on the display device; and ii) one or more displays, during play of the game, each for a predetermined display period, of a temporal operative variable selection device having at least a first outcome portion and a second outcome portion with a movable indicator configured for moving between a first position extent in the first outcome portion and a second position extent in the second outcome portion, the movable indicator moving during a predetermined travel time between the opposing first and second extent positions. The player actuating the input device during the display of the variable selection device, is awarded a respective value associated with the first and second outcome portions based on the indicator displayed in the respective first and second outcome portions when the variable selection device is selectively actuated.

In another aspect, the present invention in an illustrative embodiment provides a gaming system for awarding a prize based on a skillful operation, comprising at least one input device; at least one display device; and at least one processor. The processor is configured to: i) receive one or more requests, via the input device, from a player for play of game actions during a game for display on the display device; and ii) one or more displays, during play of the game, each for a predetermined display period, of a temporal operative variable selection device having a win portion and a non-win portion with a movable indicator configured for moving between a first position extent in the win portion and a second position extent in the non-win portion, the movable indicator moving during a predetermined travel time between the opposing first and second extent positions. The player actuating the input device during the display of the variable selection device, is awarded a value if the indicator is in the win portion of the variable selection device.

In another aspect, the present invention provides a computer-implemented method for providing a game featuring a skill-based award, comprising the steps of:

(a) receiving, by at least one processor, an indication of a user desire to participate in the skill-based game;

(b) conducting, by the at least one processor, play of the game;

(c) displaying one or more times during play of the game, a variable selection device having a first outcome portion and a second outcome portion with a movable indicator configured for moving between a first position extent in the first outcome portion and a second position extent in the second outcome portion, the movable indicator moving during a predetermined travel time between the opposing first and second extent positions;

(d) actuating selectively by the player an input device during the display of the variable selection device; and

(e) awarding a respective value based on the display of the indicator in the first outcome portion and the second outcome portion of the variable selection device during actuation of the input device.

In another aspect, the present invention provides a computer-implemented method for providing a skill-based game, comprising the steps of:

(a) receiving, by at least one processor, an indication of a user desire to participate in the skill-based game;

(b) conducting, by the at least one processor, play of a skill-based game;

(c) displaying one or more times during play of the skill-based game, a variable selection device having a win portion and a non-win portion with a movable indicator configured for moving between a first position extent in the non-win portion and a second position extent in the win portion, the movable indicator moving during a predetermined travel time between the opposing first and second extent positions;

(d) actuating by the player the input device during the display of the variable selection device; and

(e) awarding a value if the indicator is in the win portion of the variable selection device during actuation of the input device.

In another aspect, the present invention provides a computer-implemented method for providing a game having a skill-based award, comprising the steps of:

(a) receiving, by at least one processor, an indication of a user desire to participate in game featuring a skill-based award;

(b) operating, by the at least one processor, a game play having one or more user actions;

(c) during game play, displaying a temporal operative variable selection device having at least a first outcome portion and a second outcome portion with a movable indicator configured for moving between a first position extent in the first outcome portion and a second position extent in the second outcome portion, the movable indicator moving during a predetermined travel time between the opposing first and second extent positions;

(f) requiring, by the at least one processor, a player to actuate the input device during the display of the variable selection device; and

(g) awarding a value associated with the respective first outcome portion and the second outcome portion based on the displayed location of the indicator when the input device actuates.

In another aspect, the present invention provides a computer-implemented method for providing a skill-based game, comprising the steps of:

(a) receiving, by at least one processor, an indication of a user desire to participate in the skill-based game;

(b) conducting, by the at least one processor, play of a skill-based game;

(c) displaying one or more times during play of the skill-based game, a variable selection device having a win portion and a non-win portion with a movable indicator configured for moving between a first position extent in the non-win portion and a second position extent in the win portion, the movable indicator moving during a predetermined travel time between the opposing first and second extent positions;

(d) actuating by the player the input device during the display of the variable selection device; and

(e) awarding a value if the indicator is in the win portion of the variable selection device during actuation of the input device.

In another aspect, the present invention provides a computer-implemented method for providing a skill-based game, comprising the steps of:

(a) receiving, by at least one processor, an indication of a user desire to participate in the skill-based game;

(b) simulating, by the at least one processor, a first rotation of at least one displayed simulated reel comprising a first plurality of symbols;

(c) determining, by the at least one processor, if a provisional win is displayed within the simulated reels;

(d) prior to the next simulated rotation of the displayed at least one simulated reel, generating, by the at least one processor, a second plurality of symbols in one or more areas separate from the displayed at least one simulated reel, wherein the second plurality of symbols are each different than the first plurality of symbols;

(e) displaying a temporal operative variable selection device having a win portion and a non-win portion with a movable indicator configured for moving between a first position extent in the win portion and a second position extent in the non-win portion, the movable indicator moving during a predetermined travel time between the opposing first and second extent positions;

(f) requiring, by the at least one processor, a player to actuate the input device during the display of the variable selection device; and

(g) awarding a value if the indicator is in the win portion of the variable selection device during actuation of the input device, in order to win the game;

(h) determining, by the at least one processor and based on the user selection, if the user made the correct selection, and if so, converting the provisional win to an actual win; and

(i) repeating the steps for at least one subsequent game.

Objects, advantages and features of the present invention will be readily ascertained upon a reading of the following detailed description of illustrative embodiments in conjunction with the drawings.

### BRIEF DESCRIPTION OF THE DRAWINGS

FIG. 1 illustrates an electronic display screen for display of a play of a skill-based game.

FIG. 2 illustrates a first exemplary embodiment of a temporal operative skill-based variable selection control device that includes a win portion and a non-win portion with a movable indicator configured for moving between a first position extent in the win portion and a second position extent in the non-win portion, for use during play of a game.

FIG. 3 illustrates a second exemplary embodiment of a temporal operative skill-based variable selection control device that includes a win portion and opposing non-win portions with a movable indicator configured for moving between a first position extent and a second position extent for sweeping movingly across the non-win portion, the win portion, and the second non-win portion, for use during play of a game.

FIGS. 4A-4E illustrate a detailed portion of the electronic display screen that, during play of the game, displays the second embodiment of the temporal operative skill-base variable selection control device, for use during play of a game.

FIG. 5 illustrates a third exemplary embodiment of a temporal operative skill-based variable selection control device that includes a win portion and opposing non-win portions optionally with a movable indicator configured for moving between a first position extent and a second position extent for sweeping movingly across the non-win portion and the win portion, for use during play of a game.

FIGS. 6A-6D illustrate a detailed portion of the electronic display screen that, during play of the game, displays the third embodiment of the temporal operative skill-based variable selection control device, for use during play of a game.

FIG. 7 illustrates display of an electronic game that includes a temporal operative skill-based variable selection control device in accordance with the present invention.

FIG. 8 illustrates a flow chart showing an exemplary process for a game using the temporal operative skill-based variable selection control device in accordance with the present invention.

FIG. 9 illustrates an optional display in an alternate embodiment for a player to select and set the rate for movement of the movable indicator 56 of the temporal operative skill-based variable selection control device.

FIG. 10 illustrates an alternate embodiment of the skill-based temporal operative selection control device for selective play for award of a first outcome and a second outcome.

FIG. 11 illustrates an alternate embodiment of the skill-based temporal operative selection control device for selective play for award of a selected one of a plurality of outcomes.

FIG. 12 illustrates an alternate embodiment of the skill-based temporal operative selection control device for selective play for award of one of a plurality of winning outcomes and a non-win outcome.

### DETAILED DESCRIPTION

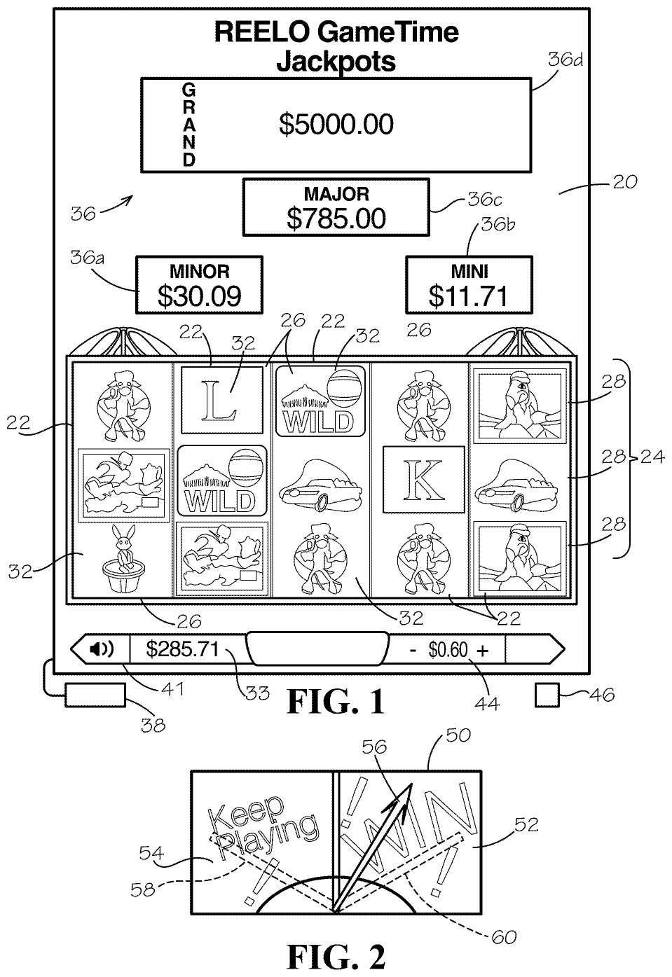

With reference to the drawings in which like parts have like reference numerals, FIG. 1 illustrates an electronic display screen 20 for display of a play of an electronic game. The game includes a skill-based award feature discussed below that is operative during play of the game. The illustrated electronic game comprises one or more simulated rotatable reels 22 displayed in a matrix format generally 24 of columns 26 and rows 28. It is to be a appreciated that other electronic games may gainfully use the skill-based feature of the present invention and such games are not limited to the reel-type game presented herein for illustrative purposes. The illustrated game embodiment displays a reel-type game having a game play matrix 24 of 5 columns and 3 rows. Any number of columns or rows may be utilized. Each reel 22 includes a set of a plurality of symbols 32. The symbols 32 may be characters, graphics, letters, numbers, or ornamental shapes. During play, the simulated reels 22 rotate to pass the sequence of symbols 32 through the matrix 34. The reels 22 stop after a rotation period, and may stop together, individually, or in groups. The game determines whether the matrix 24 displays a winning combination of symbols (for example in the illustrated embodiment, 3 or more of the same one of the symbols 32 in one or more of the rows 28.) If a winning combination results from the rotation play of the game, award values are awarded to the player, which award values are displayed in an award accumulator 33. The award values may be in terms of monies, tokens, additional spins, or other prize elements.

The electronic display screen 20 may further display generally 36 one or more prizes that may be won during play, for example, a minor prize 36a, a mini prize 36b, a major prize 36c, and grand prize 36d, each of which may be randomly awarded based conventionally on player participation entry fee and expected plays while accommodating game administration costs and prizes. A game controller includes a microprocessor 38 configured with software instructions for the game play actions as well as providing operation of the display 20 and game play input devices such as a player input button 46. The game conventionally includes a sound control button 41, a player win accumulator 33, player participation entry fee indicator 44, and the player input button 46 for instructing game activity (e.g., start game play, continue game play, and select a play option). The sound control button 40 accesses adjustor for sound level such as for music and entertainment sounds of the game during play. The player participation entry fee may be selectively set by the player with adjustors (illustrated with a “−” for reduction and “+” for increase).

To enhance player involvement and excitement during play of the game, the present invention provides a temporal operative skill-based play feature. FIG. 2 illustrates an exemplary embodiment of a skill-based variable selection control device 50 that includes at least a first outcome portion and a second outcome portion with a selectively actuated indicator for achieving of a respective award based on the indictor position when actuated. More particularly in the illustrated embodiment, the first outcome portion is a win portion 52 and the second outcome portion is a non-win portion 54. The temporal operative skill-based variable selection control device 50 includes a movable indicator 56 configured for moving between a first position extent 58 in the win portion 52 and a second position extent 60 in the non-win portion 54, for skillful use by a player during play of a game. The movable indicator 56 moves during a predetermined travel period. The predetermined travel period may be in a range of time from a minimum period for a more experienced player to a maximum period for a less skilled player. The predetermined travel period may be between less than one second to about 10 seconds, in which the player may selectively activate the selection control device 50 such as by operation of the input button 46. The skill-based variable selection control device 50 may be used for selecting in the win portion 52 gaming game play actions, triggering access to a bonus play event, or awarding win values of various types including but not limited to game credit values such as monetary or game play tokens, additional spins or game play opportunities, prizes, extended time, or other, during play of the game.

The game controller includes the microprocessor 38 configured with software instructions for the play activities as well as providing operation of the display 20 and game play input devices such as the player input button 46. The indicator 56 is configured for sweeping movement between the first position extent 58 in the win portion 52 and the second position extent 60 in the non-win portion 54, for use during play of a game. The player presses the input button 46 to select the activation of the control device 50 based on the location of the indicator 56. If the indicator 56 is within the win portion 52 when the input button 46 is pressed, activated, or indicated, the player wins a prize value associated with the win portion. While the foregoing relates to the particular illustrative embodiment, it is to be appreciated that embodiments may provide awards of differing values or actions associated with the first outcome portion and the second outcome portion, whereby skilled actuation by a player selects a particular one of the possible outcomes or awards.

The temporal operative skill-based feature may include variables that affect the operation and on which skills may be developed for play of the game. The variable selection control device 50 may be displayed for action during a first predetermined period. The predetermined display period is selected from a range between a first time period and a second time period, the second time period longer than the first time period. For example, the first time period for the display period may be short, such as several seconds, to longer, such as 10 seconds. The duration of the display period in one display event may differ from a subsequent display event, but provides multiple sweeps of the indicator 56 so that the player may observe and act on the sweep action of the indicator. If the player does not activate the input device 46 within the first predetermined period, the display of the variable selection control device 50 is removed. In such event, the player fails to utilize the opportunity during that portion of the game. The game may re-present the variable selection control device 50 during subsequent play of the game.

The display of the variable selection device also terminates if the player actuates the input device 46 with the indicator 56 in the win portion 52 of the skill-based variable selection device 50. The game may re-present the skill-based variable selection control device 50 during subsequent play of the game.

The sweep time of the indicator 56 may be set selectively for the predetermined period to move between the first and second position extents 58, 60; for example, slow (for beginner player level), medium (for intermediate experienced player), or fast (for experienced or skilled player level), such as a sweep time selected from a range of less than 1 second to 10 seconds, or more. As a player develops skill in coordinating activation of the player input button 46 relative to the sweep position of the indicator 56, the game may adjust the sweep time. For example, a player with a higher experience or skill level of game play may be presented with a faster sweep of the indicator 56. In an illustrative embodiment, the game may set a 2.5 second sweep for a beginner player; an intermediate player with a 1.75 second sweep; and an experienced player with a 1 second or less sweep period.

In reference to FIG. 9, the game displays in an alternate embodiment a skill selector 170 on the display screen 20 by which a player may select a skill factor based on game experience and set the rate for movement of the movable indicator 56 during the predetermined travel (sweep) time, for example, for beginner level 172 (slow sweep), intermediate level 174 (middle sweep rate), or skilled level 176 (fast sweep). The skilled level 176 requires the player exercise a quicker evaluation and operation of the temporal operative skill-based selection control device by operation of the input button 46 in order to timely win. To encourage players, the game optionally offers a resultant successful actuation at the higher level a greater range or value of potential awarded prizes, tokens, spins, or merchandise, than the awardable win values for the lower movement rate such as the beginner level. The game thereby encourages play and development of observation and response skills by the player selecting a skill level at which to play. Thus, the easier selective operation may result in a smaller or lesser range of win values than successful operation during the more difficult skill level play.

In an alternate embodiment, the predetermined travel period during play of the game is randomly set to a play level of beginner, intermediate or skilled. The player thus must recognize and react for timely selection within the win portion 52.

In an alternate embodiment, the movement of the movable indicator 56 commences at a first rate and accelerates to a higher quicker moving rate as time passes during the predetermined display period. Thus, a player who takes more time to make a selection using the input button 46 experiences the movable indicator 56 moving or sweeping more quickly.

In an alternate embodiment, the rate of movement of the movable indicator 56 varies during the display of the movement.

Further, the skill-based feature may include a dwell period during which the indicator pauses before resuming sweeping travel. In one embodiment, the dwell period occurs at the respective first or second position extent 58, 60 before reverse travel to the opposing second or first position extent. For example, the dwell period may be a fixed second predetermined period. Alternatively, the dwell period may be a variable predetermined period, for example, in range from about 1 second to about 5 seconds. Further, during play of the gaming system, the predetermined dwell period may change from an initial time period to a subsequent time period different, for example, shorter or alternatively longer, than the initial time period.

The game may provide notice to the player of the changes in the skill factors of the presentation time, the sweep time, and the dwell time. Such notice may be combined with laudatory messaging and alerting lights and sounds for entertainingly recognizing the developing skills of the player and presenting more challenging skill actions for subsequent plays of the variable selection control device 50. Further, the game alternatively may be configured to award more valuable win awards, prizes, or game actions, when changes to the skill feature factors make the skill action more challenging.

The display of the variable selection device 50 terminates before the end of the first predetermined display period if the player actuates the input device 46 with indicator 56 in the non-win portion 54 of the variable selection device. The game may re-present the variable selection control device 50 during subsequent play of the game.

The win value may be in terms of a monetary amount that adds to a player win accumulator, one or more additional opportunities for play of the game, for example, additional spins of simulated reels of a reel-type random event game, a merchandise award, a jackpot win, a qualification or pre-selection of the player for entry and participation in a gaming tournament, or other value item for increasing or maintain player interest in continued play of the game.

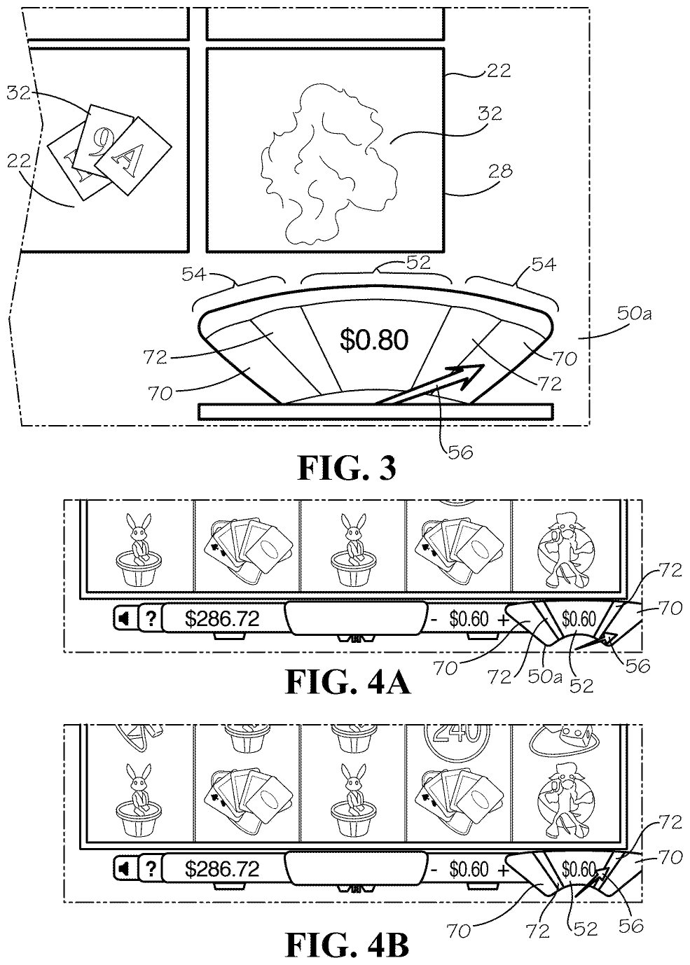

FIG. 3 illustrates a second exemplary embodiment of a temporal operative skill-based variable selection control device that includes the win portion 52 and a pair of non-win portions 54 on opposing sides with the movable indicator 56 configured for moving between the first position extent and the second position extent for sweeping movingly across a first non-win portion 54, the win portion 52, and a second non-win portion 54, for use during play of a game. The non-win portions 54 in the illustrative embodiment comprise opposing fields on opposing sides of the displayed win portion 52. The variable selection control device 50 has a first position extent 62 and a second position extent 64 with a sweep field across the respective non-win portions 54 and the win portion 52. Further, in the illustrative embodiment, the respective non-win portions 54 are optionally further subdivided into a closed non-win portion 70 and an alerting non-win portion 72. The closed non-win portion 70 may be displayed in a form distinctive from the display of the alerting non-win portion 72. The alerting non-win portion 72 may be shown in yellow, or caution, when the indicator 56 is within that portion while the closed non-win portion 70 may be shown in red, or stop. This provides an alerting visual message to the player. The win portion 52 may be displayed distinctively, for example in green for go, for a visual alert to the player for operation of the player input button 46.

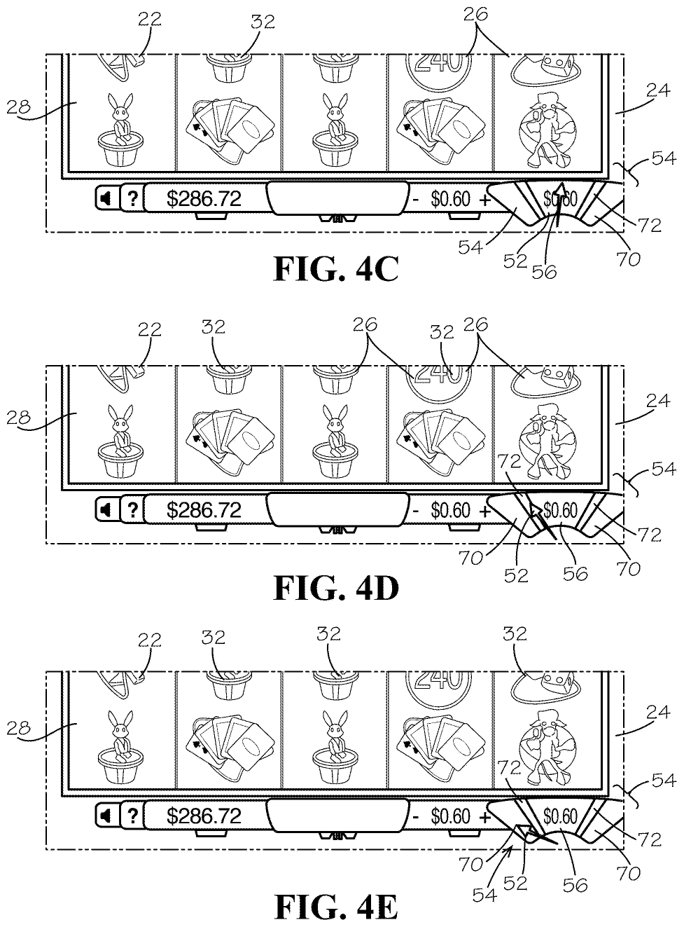

FIGS. 4A-4E illustrate the detailed portion of the electronic display screen 20 that, during play of the game, displays the temporal operative skill-based variable selection control device 50 according to the second illustrative embodiment of the present invention. FIG. 4A displays the indicator 56 in the closed non-win field 72. If the player unskillfully depresses the input button 46, the skill-based variable selection control device 50 terminates display and no value is awarded. FIG. 4B displays the indicator 56 in the alerting portion 72, which may be illustrated in a yellow color. FIG. 4C illustrates the indicator 56 in the win portion 52. If the player skillfully depresses the input button 46 during overlying occupancy of the win portion 52, the game awards a prize value to the player and the skill-based variable selection control device 50 then terminates. FIG. 4D illustrate the indicator 56 in the alerting portion 72 of the second non-win portion 52. FIG. 4E illustrates the indicator 56 in the closed non-win field 72 of the second non-win field. If the player unskillfully depresses the input button 46, the skill-based variable selection control device 50 terminates display and no value is awarded.

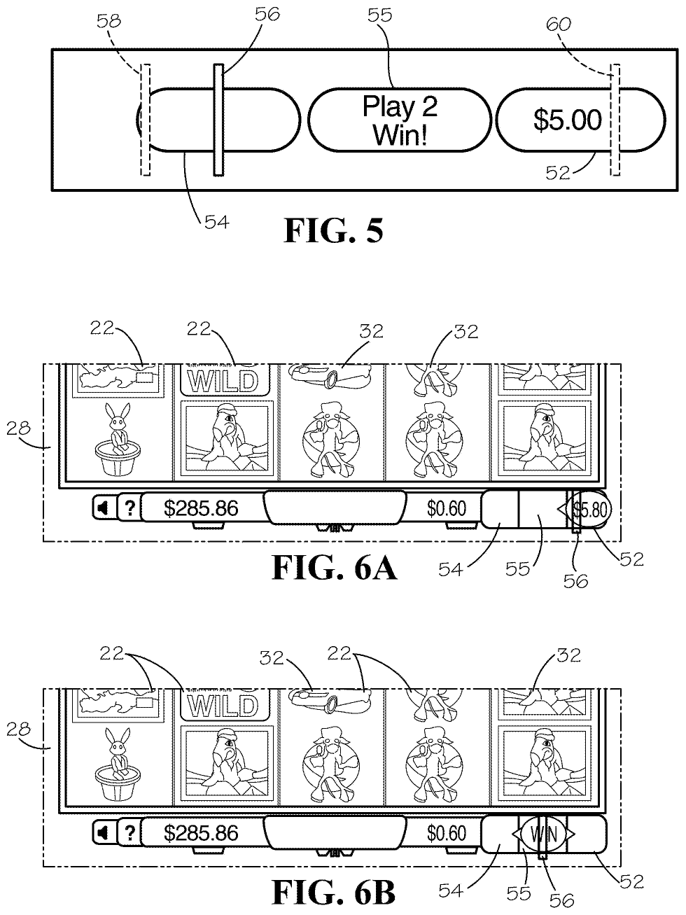

FIG. 5 illustrates a third exemplary embodiment of a temporal operative skill-based variable selection control device 50b that includes the win portion 52 and non-win portion 54 optionally with a movable indicator 56 illustrated as a vertical line configured for moving between a first position extent and a second position extent for sweeping movingly across the non-win portion and the win portion, for use during play of a game. In this embodiment, the win portion 52 and non-win portion 54 are spaced apart separated by an encouraging non-play field 55. In an alternate embodiment the respective portion 52, 54 illuminates or is displayed in a bright color for entertaining display of the skill-based variable selection control device 50b. If the player actuates the input button 46 when the indicator 56 is within the win portion 52, the game awards the prize value to the player. If the player actuates the input button 46 when the indicators 56 is within the non-win portion, the displayed skill-based variable selection control device 56 terminates and no prize value is awarded. The encouraging non-play (not active) field 55 may display encouraging or laudatory messages to the player.

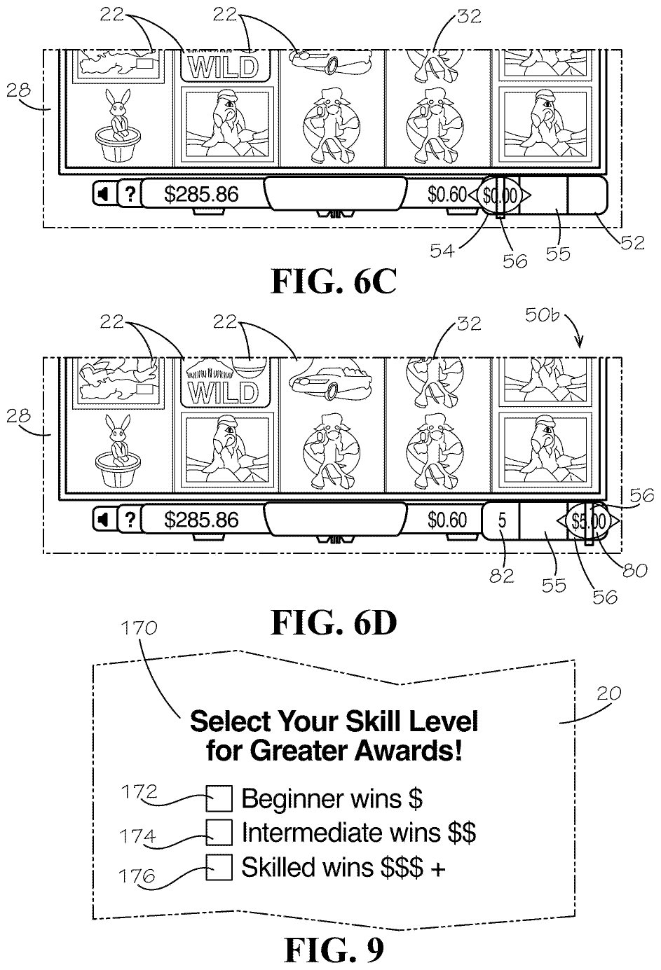

FIGS. 6A-6C illustrate the third embodiment of the temporal operative skill-based variable selection control device 50 displayed during play of the game. FIG. 6A illustrates the alternate embodiment with the win portion 52 displayed in a bright green color. If the player actuates the input button 46 during such display, the prize value is awarded. FIG. 6B illustrates the non-play portion 55 illuminated. If the player actuates the input button 46 during such display, no prize value is awarded. Optionally, the player may continue with skillful effort at seeking an award. Alternatively, actuation of the input button 46 during display of the non-play portion 55 terminates the display of the selection control device 50. FIG. 6C illustrates the non-win portion 54 illuminated, such as in a red color. If the player unskillfully actuates the input button 46 during such display, no prize value is awarded and the skill-based variable selection control device 50 terminates.

An alternate of the third embodiment of the temporal operative skill-based variable selection control device 50 does not use the movable indicator 56 but rather displays the win portion 52 with non-play portion 55 and non-win portions not displayed, or darkened. During the predetermined travel period, the game fades the win portion 52 simulating the movement of the indicator 56 and then suddenly the win portion 52 darkens to indicate the field is inactive and the non-play portion 55 illuminates encouragingly. As the time passes, the non-play portion 55 fades until suddenly dark and the non-win portion 54 illuminates. The sequence may then reverse, with the non-win portion 54 fading and suddenly dark (or not active) and the non-play portion 55 illuminates. The passing of the predetermined travel period continues and the non-play portion 55 fades and suddenly darkens to indicate the field is not selectable while the win portion 52 illuminates. The player thus selects skillfully when the win portion 52 is active in order to win. The sequential illumination and fading of the respective selection portions 52, 54, and 55 provides illumination and fading as an alternate display for the selectable portions during the predetermined travel period rather than the indicator 56.

An alternate embodiment illustrated in FIG. 6D places the non-win portion 54 between opposing win positions 52. The temporal operative variable selection device 50 includes a first win portion 80, a second win portion 82, and the non-win portion 54. The movable indicator 56 is configured for moving across the win and non-win portions for the player to observe the selectable positions. In this embodiment, the temporal operative variable selection device 50 includes three outcome fields offering a first and second award in the first and second win portions 80, 82 and a third outcome of a non-win portion, which first and second awards may be different values or types in accordance with the invention.

The movable indicator 56 sweeps between the first position extent and the second position extent. The first win portion 80 and the second win portion 82 present optional win values for a player to select. For example, the first win portion 80 may provide a monetary value as a bonus that accumulates in the player win accumulator for subsequent reward and redemption. The second win portion 82 may provide a game feature useful for continuing play of the game. A game feature may be one or more additional opportunities for game play, such as additional spins of the reels (illustrated with a number of additional spins), or may be an enhanced game play characteristic, such as a game feature affording enhanced game action, for example but not limited to player option to stop a reel during rotation, to advance a selected stopped reel one or more symbol spaces, or other game enhancement.

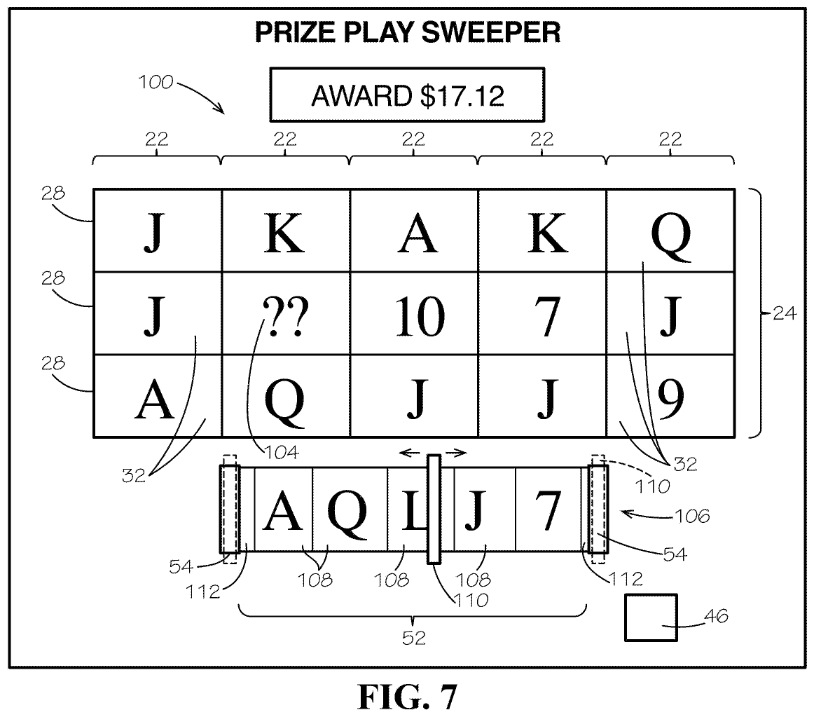

FIG. 7 illustrates a display 100 of an electronic game that includes a temporal operative skill-based variable selection control device 102 in accordance with the present invention. The electronic game 100 uses simulated rotatable reels 22 displayed in the matrix 24 of columns 26 and rows 28. While the illustrated embodiment displays a game play matrix 24 of 5 columns and 3 rows, other embodiments may use a selected different number of columns, of rows, or of each. Each reel 22 includes a set of a plurality of symbols 32. The symbols 32 may be characters, letters, numbers, or ornamental shapes. In the game, at least one of the symbols displayed in the matrix is a placeholder symbol 104. The display of the placeholder symbol 104 may be random (that is, the placeholder symbol is included in the sequence of symbols on a reel 22). Alternatively, the game substitutes one of the symbols 32 randomly in the matrix 24 with the placeholder symbol 104.

The game further includes a temporal operative skill-based variable selection control device 106. The game displays the temporal operative skill-based variable selection control device 106 for operation by the player during a predetermined display period. The control device 106 includes one or more selection fields 108 in the win portion 52 and a movable indicator 110 with non-win fields 112 in non-win portions 54 on opposing side of the sequence of the one or more selection fields 108. The non-win fields 112 each define a respective distal extent of travel for the movable indicator 110 (i.e., a first position extent and an opposing second position extent, illustrated in broken line). Each of the selection fields 108 displays one of the symbols 32 of the plurality of symbols. A selected one of the selection fields 108 provides the symbol 32 for replacing the placeholder symbol 104 during play of the game as discussed below.

The movable indicator 110 operatively moves during play between the distal extents across the non-win portions 54 and the selection fields 108 in the win portion 52, for skillful use by a player during play of a game. The movable indicator 110 thus moves in a first direction to a first distal extent and then in the opposing direction to the opposing distal extent as shown by indicator arrows. The travel of the movable indicator 110 is based on a predetermined period of time. The movable indicator 110 may have a first rate of travel, and may be selected for slow, medium, or fast. The rate may be changed for a game based on the player skill improving in selecting a winning symbol. The operation of the movable indicator 110 may include the dwell period in which the movable indicator stops for predetermined period, for example but not limited to stopping for the dwell period in the respective non-win field 112 before resuming travel, for example, in the opposing direction towards the other non-win field.

The player operates the input button 46 to select a game action based on the location of the movable indicator 110. The indicator 110 may be within the win portion 52 or in the non-win portion 54. If the indicator 110 is within a win portion 52 (i.e., within one of the one or more selection fields 108), the associated symbol replaces the placeholder symbol in the matrix 24. The temporal operative skill-based variable selection control device 106 terminates. If the indicator 110 is within the non-win portions 54 when the input button 46 is operated, the placeholder symbol is not replaced and the temporal operative skill-based variable selection control device 106 terminates. The game then continues with a subsequent spin if the player has available spins for continuing play.

During play, the simulated reels 22 rotate (or are displayed as rotating) to pass the sequence of symbols 32 of each reel through the matrix 34. The reels 22 stop after a rotation period, and may stop together, individually, or in groups. Alternatively, the game may be configured for the reels 22 to stop upon selective activation by the player of the player input button 46. In a first embodiment, the reels 22 stop together while in a second embodiment, the reels 22 stop sequentially upon repeated selective operation of the player input button 46. In this alternate configuration, if the player does not activate the input button 46, the reels stop after a predetermined period of rotation in order to advance the game.

When the reels 22 complete rotation, at least one of the symbols displayed in the matrix is the placeholder symbol 104. The display of the placeholder symbol 104 may be random (that is, the placeholder symbol is included randomly in the sequence of symbols on a reel 22). Alternatively, the game substitutes a symbol with the placeholder symbol 104.

The game determines whether the matrix 24 displays a winning combination of symbols (for example in the illustrated embodiment, 3 or more of the same one of the symbols 32 in one or more of the rows 28 or diagonals). If a winning combination results from the rotation play of the game, award values are awarded to the player, which award values are displayed in an award accumulator 33. The award values may be in terms of monies, additional spins, or other prize element.

The game then displays the substitute symbol selection fields 108 in the temporal operative skill-based variable selection control device 106 separate from the displayed matrix 24. The game requires the player to actuate the input device 46 during the display and operation of the skill-based variable selection control device 106. The player uses skill to select, during operation of the skill-based variable selection control device 106, a one of the one or more symbols in the substitute symbol selection field 108, to replace the placeholder symbol 104. The movable indicator 110 operates to sweep across the symbol selection fields 108 and the non-win fields 112. If the player operates the input button 46 while the movable indictor 110 is within a respective one of the non-win fields 112, no symbol substitution is made, the skill-based variable selection control device 106 terminates, and the game continues if the player has remaining spin plays available for selective play of the game.

If the player operates the input button 46 while the movable indictor 110 is within a respective one of the symbol selection fields 108, the respective selected symbol replaces the placeholder symbol 104 and the skill-based variable selection control device 106 terminates. The game then determines if the symbols in the matrix 24, with the selected symbol having replaced the placeholder symbol, form any winning symbol combinations (for example in the illustrated embodiment, 3 or more of the same one of the symbols 32 in one the rows 28 or diagonals across multiple reels). If a winning combination results from symbol substitution, award values are awarded to the player, which award values are displayed in an award accumulator 33. The award values may be in terms of monies, additional spins, or other prize element. The game continues if the player has remaining spin plays available for selective play of the game.

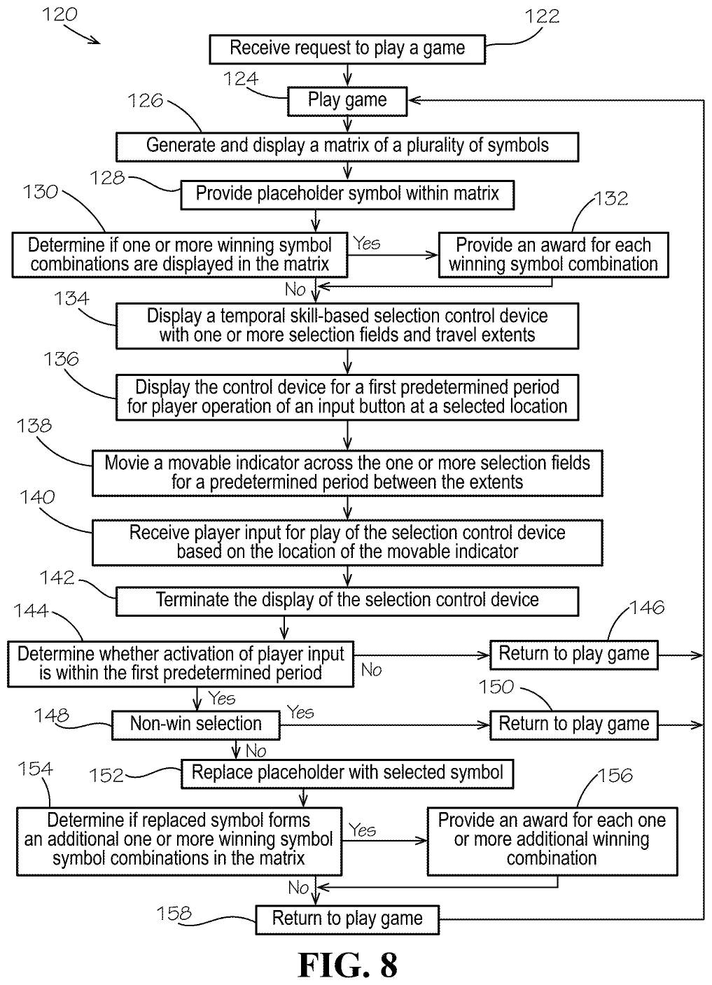

FIG. 8 illustrates a flow chart showing an exemplary process for a multi-reel random draw wager-type game 120 using the temporal operative skill-based variable selection control device in accordance with the present invention. The game commences with a request 122 by the player to play a game. This may involve the player depositing tokens, currency, credit card, or other financial transaction element in consideration of playing the game. The play of the game commences 124. As noted above, in an alternate embodiment the game may present a player skill selection menu for player selection of beginner, intermediate, or experienced skill levels with attendant differences in achievable awards for skillful operation of the displayed selection control device.

The game generates 126, and displays a matrix of a plurality of symbols. The game provides 128 a placeholder symbol within the matrix. The game then determines 130 whether one or more winning symbol combinations are displayed in the matrix. For example, a 5 reel by 3 symbol display matrix may require a sequence of three or more of the same symbol in a row, column, or diagonal. The game provides 132 an award to the player for each winning symbol combination. The game then displays 134 a temporal skill-based selection control device with one or more selection fields and travel extents for a moving indicator. The game displays the temporal skill-based selection control device for a first predetermined period 136 during which the player may operate an input button when the moving indicator is at location the player wants to select. The game moves 138 the movable indicator through the selection control device for a predetermined travel period between the extents. The game receives 140 the player input for play of the selection control device based on the location of the movable indicator. The game terminates 142 the display of the selection control device.

The game then determines 144 whether the activation of player input is within the first predetermined period. If not, the game returns 146 to the start 124 for continued play of the game, if the player has remaining credits for game play. Otherwise, the game determines 148 whether the player has unskillfully selected a non-winning portion of the selection control device. If so, the game returns 150 to the start 124 for continued play of the game, if the player has remaining credits for game play. If the player has activated the input button with the moving indicator in the win portion of the selection control device, the game replaces 152 the placeholder symbol with the symbol selected by the player. The game then determines 154 if the replaced symbol forms an additional one or more winning symbol combination in the matrix. If so, the game provides 156 an award for each of the one or more additional winning symbol combinations in the matrix. The game than returns 158 to the start 124 for continued play of the game, if the player has remaining credits for game play.

The electronic game disclosed in reference to FIG. 7 thereby provides a temporal operative skill-based selection control device for selecting by the player, if skillful, a symbol that completes a winning sequence in the matrix 24 by replacing the placeholder symbol 104 with the selected symbol. The temporal operative skill-based selection control device 106 is displayed for a predetermined period in which the player may selectively operate the input button 46. If the player does not operate the input button within the predetermined display period, the displayed temporal operative skill-based variable selection control device 106 terminates and the opportunity ends for the player to possibly complete a winning sequence in the matrix for an award. The game resumes with a subsequent opportunity for play of the skill-based variable selection control device 106. Similarly, if the player unskillfully operates the input button 46 with the movable indicator 110 in the non-win field 112, the displayed temporal operative skill-based variable selection control device 106 terminates and the opportunity ends for the player to possibly complete a winning sequence in the matrix for an award.

If the player timely operates the input button 46 with the movable indicator 110 within the one of the one or more selection fields 108, the selected symbol replaces the placeholder symbol 104 and the display of the temporal operative skill-based variable selection control device 106 terminates. The game then determines if the symbols in the matrix 24, with the selected symbol having replaced the placeholder symbol, form any winning symbol combinations, and if so, the award is awarded to the player.

The travel period of the temporal operative skill-based variable selection control device 106 between the opposing extents is based on a second predetermined period. Further, the travel may be subject to the dwell period of a third predetermined period during travel; for example but not limited to a dwell at the respective extent in the non-win field before reverse travel of the movable indicator 110 commences.

The play of the game is dependent on the skill of the player. The player must consider the location of the placeholder symbol 104 and determine what symbol would complete one or more winning sequences, and then evaluate the location of the symbol in the one or more selection fields 108. The player must skillfully consider the travel period of the movable indicator 110 for selecting to operate the input button 46 to timely select the symbol believed to provide one or more winning sequences. The player must skillfully consider the dwell period (if implemented in the game). The player must skillfully consider the remaining period of time for the display of the temporal operative skill-based variable selection control device 106 and make a selection before the game terminates the display.

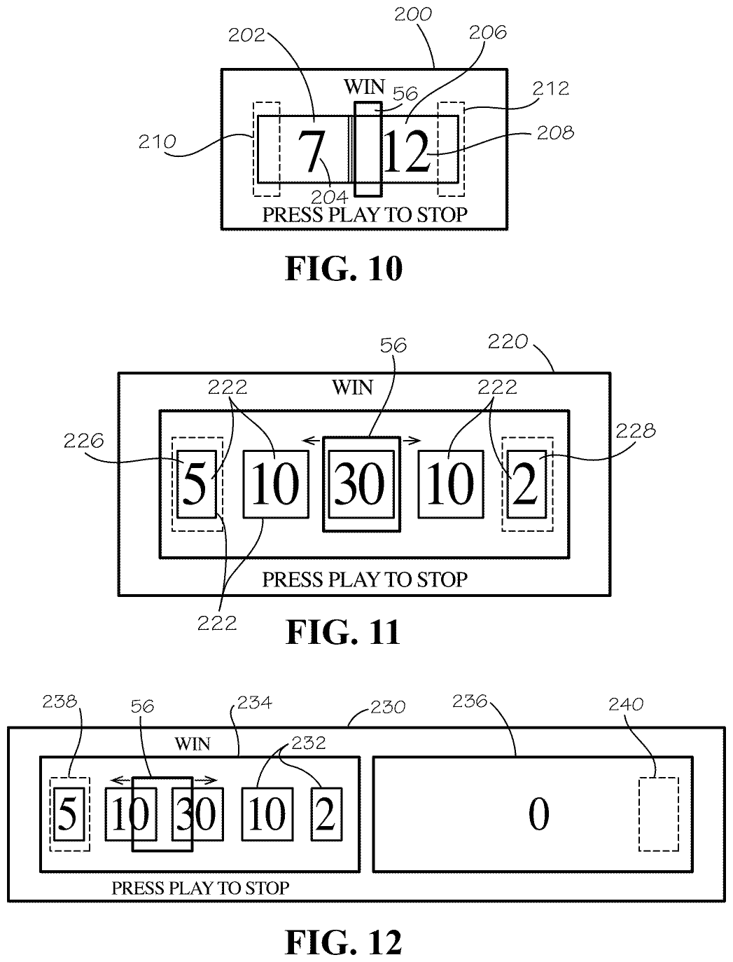

FIG. 10 illustrates an alternate embodiment of the skill-based temporal operative selection control device 56 in a game display 200 for selective play for an award of a first outcome or a second outcome. The game display 200 displays a first field 202 with a first win value 204 and a second field 206 with a second win value 208. The variable selection control device 56 moves sweepingly back and forth across the first field 202 and the second field 206 between a first extent 210 and a second extent 212. The player operates an actuator at a selected moment the control device 56 is within the particular first field 202 or second field 206 for an award of the first win value 204 or second win value 208.

The movement of the selection control device 56 during play may be operated variably as discussed above in alternate embodiments. These include the movement may occur during a predetermined period, the duration of movement may differ from that for a previously displayed game period, the duration of the predetermined period may differ based on the skill of the player (i.e., a first duration, long, for slow movement, for less experienced player; a second duration, short, for fast movement, for a skilled player; and a third duration, intermediate the first duration and the second duration, for an intermediate rate of movement, for an intermediate skilled player). Further, the operation of the selection control device 56 may include a dwell period (for example, at one or both extents or in an alternate embodiment, during the sweeping movement between the extents such as at an intermediate position), a variable dwell period that changes for example after a sweeping movement cycle, a dwell duration randomly set prior to a game play, or selectively set for example with the player skill criteria shown in FIG. 9. The movement rate may change during the display period (i.e., incrementing to a second rate of movement at the end of the period than a first rate of movement at the start, for example incrementing to a faster rate.)

FIG. 11 illustrates an alternate embodiment of the skill-based temporal operative selection control device 56 in a game display 220 for selective play for an award of a selected one of a plurality of outcomes 222 displayed in respective fields of the game display. The game display 220 displays an outcome field 224 with the respective outcomes 222. The outcomes 222 have respective win values for award if the selection control device 56 is within the respective displayed outcome field. The variable selection control device 56 moves sweepingly back and forth across the outcome field 224 between a first extent 226 and a second extent 228. The player operates an actuator at a selected moment the control device 56 is within a particular one of the outcome fields for an award of the respective win value of the outcome field.

As noted above, the movement of the control device 56 encourages development of player skill, and the operation during game play may be modified as discussed above, including period of sweeping movement, rate of movement, and dwell. More particularly, these include the movement may occur during a predetermined period, the duration of movement may differ from that for a previously displayed game period, the duration of the predetermined period may differ based on the skill of the player (i.e., a first duration, long, for slow movement, for less experienced player; a second duration, short, for fast movement, for a skilled player; and a third duration, intermediate the first duration and the second duration, for an intermediate rate of movement, for an intermediate skilled player). Further, the operation of the selection control device 56 may include a dwell period (for example, at one or both extents or in an alternate embodiment, during the sweeping movement between the extents such as at an intermediate position), a variable dwell period that changes for example after a sweeping movement cycle, a dwell duration randomly set prior to a game play, or selectively set for example with the player skill criteria shown in FIG. 9. The movement rate may increase during the display period (i.e., faster movement at the end of the period than at the start).

FIG. 12 illustrates an alternate embodiment of the skill-based temporal operative selection control device 56 for selective play during display of a game field 230 for award of one of a plurality of winning outcomes 232 displayed on a win field 234 and a non-win outcome displayed on a non-win field 236. The variable selection control device 56 moves sweepingly back and forth across the win field 234 and the non-win field 236 between a first extent 238 and a second extent 240. The player operates an actuator at a selected moment the control device 56 is within a particular one of the outcome fields for an award (win or non-win) based on the respective win value of the selected outcome field. The movement of the control device 56 is similarly operated during display of the game field as discussed above, including period of sweeping movement, rate of movement, and dwell.

The foregoing discloses illustrative embodiments of a temporal operative skill-based selection control device for use in play of a game such as an electronic random draw game, with the control device displayed periodically during the game and during display may be skillful operated by the player for award of prize values in response to the indicator sweeping across the first and second outcomes (win and non-win portions), which sweep time is a predetermined period between extent positions, may alternatively include a dwell period for pausing for example at the extent positions before commencing return or opposing direct travel or continuing travel, and alternatively providing more than one win portion for the player to select if skillful a first value type or a second value type. The written description enables one of ordinary skill in the art to practice the invention in disclosed embodiments as well as making and using alternative embodiments within the scope of the claims.

What is claimed is:

1. A gaming system, comprising:
at least one input device;
at least one display device; and
at least one processor, which is configured to:
(i) receive one or more requests, via the input device, from a player for play of game actions during a game for display on the display device;
(ii) one or more displays, during play of the game, each for a predetermined display period, of a temporal operative variable selection device having at least a first outcome portion and second outcome portion with a movable indicator configured for moving between a first position extent in the first outcome portion and a second position extent in the second outcome portion, the movable indicator moving during a predetermined travel time between the opposing first and second extent positions,
whereby the player actuating the input device during the display of the variable selection device, is awarded a respective value associated with the first and second outcome portions based on the indicator displayed in the respective first and second outcome portions when the variable selection device is selectively actuated.

2. The gaming system as recited in claim 1, wherein the first outcome portion is a win portion and the second outcome portion is a non-win portion, whereby the player is awarded a value if the indicator is in the win portion of the variable selection device.

3. The gaming system as recited in claim 2, wherein the display of the variable selection device terminates if the player actuates the input device with the indicator in the win portion of the variable selection device.

4. The gaming system as recited in claim 2, wherein the display of the variable selection device terminates before the end of the predetermined display period if the player actuates the input device with indicator in the non-win portion of the variable selection device.

5. The gaming system as recited in claim 1, wherein the predetermined display period is selected from a range between a first time period and a second time period, the second time period longer than the first time period.

6. The gaming system as recited in claim 5, wherein the first time period is 1 second.

7. The gaming system as recited in claim 5, wherein in the second time period is 20 seconds.

8. The gaming system as recited in claim 1, wherein during play of the gaming system, the predetermined display period changes from an initial time period to a subsequent time period different than the initial time period.

9. The gaming system as recited in claim 1, wherein indicator pauses from movement for a predetermined dwell period.

10. The gaming system as recited in claim 9, wherein the predetermined dwell period is selected from range between a third time period and a fourth time period, the fourth time period longer than the third time period.

11. The gaming system as recited in claim 10, wherein the third time period is 1 second and the fourth time period is 7 seconds.

12. The gaming system as recited in claim 1, wherein during play of the gaming system, the predetermined dwell period changes from an initial time period to a subsequent time period different than the initial time period.

13. The gaming system as recited in claim 1, wherein the predetermined travel period is selected from a range between a first time period and a second time period, the second time period longer than the first time period.

14. The gaming system as recited in claim 13, wherein the first time period is less than 1 second.

15. The gaming system as recited in claim 13, wherein in the second time period is 10 seconds.

16. The gaming system as recited in claim 1, wherein during play of the gaming system, the predetermined travel period changes from an initial time period to a subsequent time period different than the initial time period.

17. The gaming system as recited in claim 2, wherein the variable selection device further comprises a second win portion, whereby the player actuating the input device during the display of the variable selection device, is awarded a second value if the indicator is in the second win portion of the variable selection device.

18. The gaming system as recited in claim 1, wherein the one processor is further configured to:
(a) display on the display device, one of a first plurality of symbols at each of a plurality of symbol display positions in a matrix format of columns and rows;
(b) display, on the display device, a placeholder symbol in at least one symbol display position;
(c) display, on the display device, a second plurality of symbols in one or more areas separate from the displayed matrix symbols;
(d) require the player to actuate the input device during the display of the variable selection device,
whereby the value awarded comprises one of the second plurality of symbols which award symbol replaces the placeholder symbol, in order to win the game;
(e) replace the placeholder symbol with the user-selected second symbol;
(f) determine if the matrix symbols form any winning symbol combinations;
(g) if the matrix symbols form at least one winning symbol combination, display one of a plurality of awards for each displayed winning symbol combination; and
(h) repeat the steps for at least one subsequent game.

19. The gaming system as recited in claim 18, wherein the processor randomly determines the symbol display position for the placeholder symbol.

20. The gaming system as recited in claim 18, wherein for each game, the displayed matrix symbols, the displayed second plurality of symbols, and the placeholder symbol display position are each predetermined.

21. The gaming system as recited in claim 18, wherein the processor analyzes the displayed matrix symbols to determine an optimal symbol display position for the placeholder symbol.

22. The gaming system as recited in claim 18, wherein the processor analyzes the displayed matrix symbols and the displayed second plurality of symbols to determine an optimal symbol display position for the placeholder symbol.

23. The gaming system as recited in claim 18, wherein the player selectively determines the symbol display position for the placeholder symbol.

24. The gaming system as recited in claim 18, wherein the second plurality of symbols comprises two symbols.

25. The gaming system as recited in claim 18, wherein the second plurality of symbols comprises four symbols.

26. The gaming system as recited in claim 18, wherein the second plurality of symbols comprises eight symbols.

27. The gaming system as recited in claim 18, wherein the second plurality of symbols comprises at least one wild symbol.

28. The gaming system as recited in claim 18, wherein the first plurality of symbols comprises at least one wild symbol that takes on a characteristic of an adjacent symbol during game play to generate a winning symbol combination based on the selection of the replacement one of the second plurality of symbols.

29. The gaming system as recited in claim 1, further comprising a skill selector with a plurality of movement rates for selective movement of the movable indicator during the predetermined travel time in a range from a first movement rate to a second movement rate, said second movement rate faster than the first movement rate, whereby a player may select a skill factor for play of the game based on experience.

30. A computer-implemented method for providing a skill-based game, comprising the steps of:
(a) receiving, by at least one processor, an indication of a user desire to participate in the skill-based game;
(b) conducting, by the at least one processor, play of a skill-based game;
(c) displaying one or more times during play of the skill-based game, a temporal operative variable selection device having a first outcome portion and a second outcome portion with a movable indicator configured for moving between a first position extent in the first outcome portion and a second position extent in the second outcome portion, the movable indicator moving during a predetermined travel time between the opposing first and second extent positions;
(d) actuating by the player the input device during the display of the variable selection device; and
(e) awarding a respective value based on the display of the indicator in the first outcome portion and the second outcome portion of the variable selection device during actuation of the input device.

31. The computer-implemented method as recited in claim 30, wherein the first outcome portion comprises a win portion and the second outcome portion comprises a non-win portion; and wherein the game awards a value if the indicator is in the win portion of the variable selection device during actuation of the input device.

32. The computer-implemented method as recited in claim 30, further comprising the step of decreasing, by the at least one processor, an account balance associated with the user.

33. The computer-implemented method as recited in claim 30, wherein the conducting of the game comprises the steps of:
simulating, by the at least one processor, a first rotation of at least one displayed simulated reel comprising a first plurality of symbols;
displaying, by the at least one processor, a placeholder symbol in at least one symbol display position;
prior to the next simulated rotation of the displayed at least one simulated reel, generating, by the at least one processor, a second plurality of symbols in one or more areas separate from the displayed at least one simulated reel, wherein the second plurality of symbols are a subset of the first plurality of symbols; and
requiring, by the at least one processor, actuation of the input device by the player in response to the display of the variable selection device;
wherein the value comprises a selected one of the second plurality of symbols to replace the placeholder symbol in order to win the game;
replacing, by the at least one processor, the placeholder symbol with the user-selected second symbol;
determining, by the at least one processor and based on the user selection, if the symbols on the simulated reel display a winning combination of symbols;
increasing, by the at least one processor, the account balance associated with the user for a winning combination determined by the processor; and
repeating the steps for at least one subsequent game.

34. The computer-implemented method as recited in claim 33, wherein the processor randomly determines the symbol display position for the placeholder symbol.

35. The computer-implemented method as recited in claim 33, wherein for each game, the displayed matrix symbols, displayed second plurality of symbols, and placeholder symbol display position are each predetermined.

36. The computer-implemented method as recited in claim 33 wherein the processor analyzes the displayed matrix symbols to determine the optimal symbol display position for the placeholder symbol.

37. The computer-implemented method as recited in claim 33, wherein the processor analyzes the displayed matrix symbols and the displayed second plurality of symbols to determine the optimal symbol display position for the placeholder symbol.

38. The computer-implemented method as recited in claim 30, further comprising a skill selector with a plurality of movement rates for selective movement of the movable indicator during the predetermined travel time in a range from a first movement rate to a second movement rate, said second movement rate faster than the first movement rate, whereby a player may select a skill factor for play of the game based on experience.

39. A computer-implemented method for providing a skill-based game, comprising the steps of:
(a) receiving, by at least one processor, an indication of a user desire to participate in the skill-based game;
(b) simulating, by the at least one processor, a first rotation of at least one displayed simulated reel comprising a first plurality of symbols;
(c) determining, by the at least one processor, if a provisional win is displayed within the simulated reels;
(d) prior to the next simulated rotation of the displayed at least one simulated reel, generating, by the at least one processor, a second plurality of symbols in one or more areas separate from the displayed at least one simulated reel, wherein the second plurality of symbols are each different than the first plurality of symbols;
(e) displaying a temporal operative variable selection device having a win portion and a non-win portion with a movable indicator configured for moving between a first position extent in the non-win portion and a second position extent in the win portion, the movable indicator moving during a predetermined travel time between the opposing first and second extent positions;
(f) requiring, by the at least one processor, a player to actuate the input device during the display of the variable selection device; and
(g) awarding a value if the indicator is in the win portion of the variable selection device during actuation of the input device, in order to win the game;
(h) determining, by the at least one processor and based on the user selection, if the user made the correct selection, and if so, converting the provisional win to an actual win; and
(i) repeating the steps for at least one subsequent game.

40. The computer-implemented method as recited in claim 39, further comprising the step of increasing, by the at least one processor, the account balance associated with the user with a win value.

41. The computer-implemented method as recited in claim 39, wherein the provisional win is visually displayed to the user.

42. The computer-implemented method as recited in claim 39, wherein the second plurality of symbols are unrelated to the first plurality of symbols.

43. The computer-implemented method as recited in claim 39, wherein the second plurality of symbols are numbers.

44. The computer-implemented method as recited in claim 39, wherein for each game, the displayed first plurality of symbols and the displayed second plurality of symbols are each predetermined.

45. The computer-implemented method as recited in claim 39, wherein after the step of receiving the indication of the user to participate in the skill-based game, further comprising the step of decreasing, by the at least one processor, an account balance associated with the user.

46. The computer-implemented method as recited in claim 39, further comprising displaying a skill selector with a plurality of movement rates for selective movement of the movable indicator during the predetermined travel time in a range from a first movement rate to a second movement rate, said second movement rate faster than the first movement rate, whereby a player may select a skill factor for play of the game based on experience.
